(19) United States
(12) Patent Application Publication
(10) Pub. No.: US 2016/0010773 A1
(43) Pub. Date: Jan. 14, 2016

(54) Component Mount Integrated With Tube Fitting

(71) Applicant: UNITED TECHNOLOGIES CORPORATION, Hartford, CT (US)

(72) Inventors: Thomas Bruce Avis, Machester, CT (US); Michael Dreher, Prospect, CT (US)

(73) Assignee: UNITED TECHNOLOGIES CORPORATION, Hartford, CT (US)

(21) Appl. No.: 14/759,879

(22) PCT Filed: Jan. 20, 2014
(86) PCT No.: PCT/US2014/012191

§ 371 Date: Jul. 8, 2015

Related U.S. Application Data
(60) Provisional application No. 61/754,344, filed on Jan. 18, 2013.

(51) Int. Cl. F16L 23/02; F01D 25/28; F01D 25/24

(52) U.S. Cl. CPC F16L 23/02; F01D 25/24; F01D 25/28

(57) ABSTRACT

A component mount is disclosed which may comprise a tube fitting having first and second ends, a bracket extending from the tube fitting, and a mount extending from the tube fitting. The component mount may be used to mount a line replaceable unit to a casing of a gas turbine engine.

### CROSS-REFERENCE TO RELATED APPLICATION

This patent application is a US National Stage under 35 U.S.C. §371, claiming priority to International Application No. PCT/US14/12191 filed on Jan. 20, 2014, which claims priority under 35 U.S.C. §119(e) to U.S. Patent Application Ser. No. 61/754,344 filed on Jan. 18, 2013.

### FIELD OF THE DISCLOSURE

The present disclosure generally relates to gas turbine engines and, more specifically, relates to external components mounted on a gas turbine engine.

### BACKGROUND OF THE DISCLOSURE

Gas turbine engines are highly complex pieces of machinery with many different components. Internally, a typical gas turbine engine includes, broadly speaking, a fan, a compressor, a combustor and a turbine arranged in axial fashion through the engine. Each of those components is surrounded by an engine case to which a plurality of components, generally referred to as externals, are mounted. Such externals typically include tubing, motors, filters, and other components which occupy a majority of the exterior surface of the engine case.

Moreover, as engine design has evolved and the performance characteristics have been enhanced, reductions in engine weight and size are continually being sought. While such reductions are helpful in terms of efficiency and fuel economy, it makes the task of mounting all the aforementioned externals more and more difficult as space is more and more at a premium. This is made more problematic in the mounting of line replaceable units which, by necessity, have to be mounted in such a way as to allow for such units to easily accessed by maintenance personnel and service technicians, and easily removed and replaced if necessary.

Accordingly, it can be seen that a need exists for a mounting system that allows line replaceable units to accessed and replaced, in a secure fashion, while at the same time limiting the overall space requirements of the engine.

### SUMMARY OF THE DISCLOSURE

In accordance with one aspect of the disclosure, a component mount is disclosed which may comprise a tube fitting having first and second ends, a bracket extending from the tube fitting, and a mount extending from the tube fitting.

In accordance with another aspect of the disclosure, a gas turbine engine is disclosed which may comprise an engine case, a tube operatively associated with the engine case, a tube fitting mounted on the tube, a bracket connecting the tube fitting to the engine case, and a mount extending from the tube fitting.

These and other features and aspects of the disclosure will be more readily understood upon reading the following detailed description when taken in conjunction with the accompanying drawings.

### BRIEF DESCRIPTION OF THE DRAWINGS

FIG. 1 is a perspective view of a gas turbine engine constructed in accordance with the teachings of this disclosure;

FIG. 2 is a perspective view of component mount constructed in accordance with the teachings of this disclosure; and

FIG. 3 is a cross-sectional view of the component mount of FIG. 2.

### DETAILED DESCRIPTION

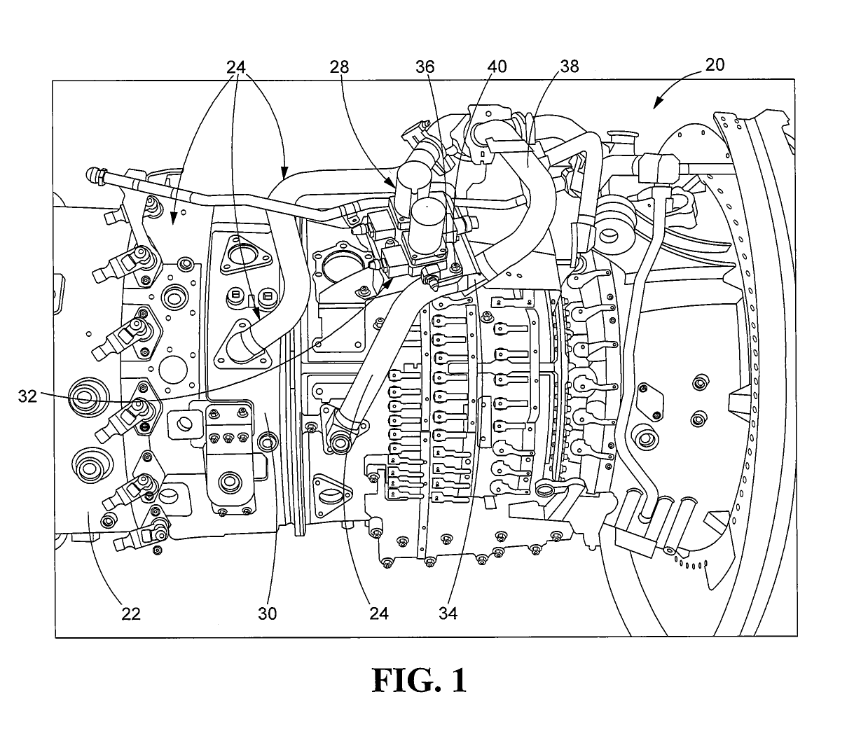

Referring now to the drawings, and with specific reference to FIG. 1, a gas turbine engine constructed in accordance with the teachings of the disclosure is generally referred by reference numeral 20. While the drawings and following description will be made with reference to the gas turbine engine 20, it is to be understood that the teachings of this disclosure can be employed with equal efficacy in connection with any number of machines, including internal combustion engines, machine tools, assembly lines, and other piece of machinery where space is limited but a secure mounting system is needed.

As shown, the gas turbine engine 20 includes an engine case 22 to which a plurality of external components 24 are mounted. In addition, while not shown, it is to be understood that the gas turbine engine 20 would include a fan, a compressor, a combustor, and a turbine (all of which are not shown) internal to the engine case 22 for normal operation of the engine 20. One of ordinary skill in the art will readily understand how such a gas turbine engine would operate in principle.

Included among the external components 24 are a plurality of tubes 26 and at least one line replaceable unit (LRU) 28. The line replaceable unit 28 may be any number of different components which need to be periodically replaced during the life of the engine, such as, but not limited to, torque motors, valves and filters. With prior art approaches, such line replaceable units would be mounted directly to the engine case 22 to provide a secure load path to the engine. However, as engine design has advanced, the exterior space 30 available on the engine case 22 has been reduced. In addition, certain line replaceable units 28 have to be mounted in relatively exact locations in order to operate effectively and efficiently.

The present disclosure therefore drastically departs from the prior art by providing a mounting system 32 that enables such line replaceable units 28 to be mounted exactly where the engine designer wants, while not occupying any additional exterior space 30 of the engine case. The present disclosure does so by employing a tube fitting 34 which simultaneously allows for tubes 26 to be interconnected, while at the same time providing a mounting surface 36 for the line replaceable units 28 and providing a load path for the line replaceable unit 28 down to the engine 20.

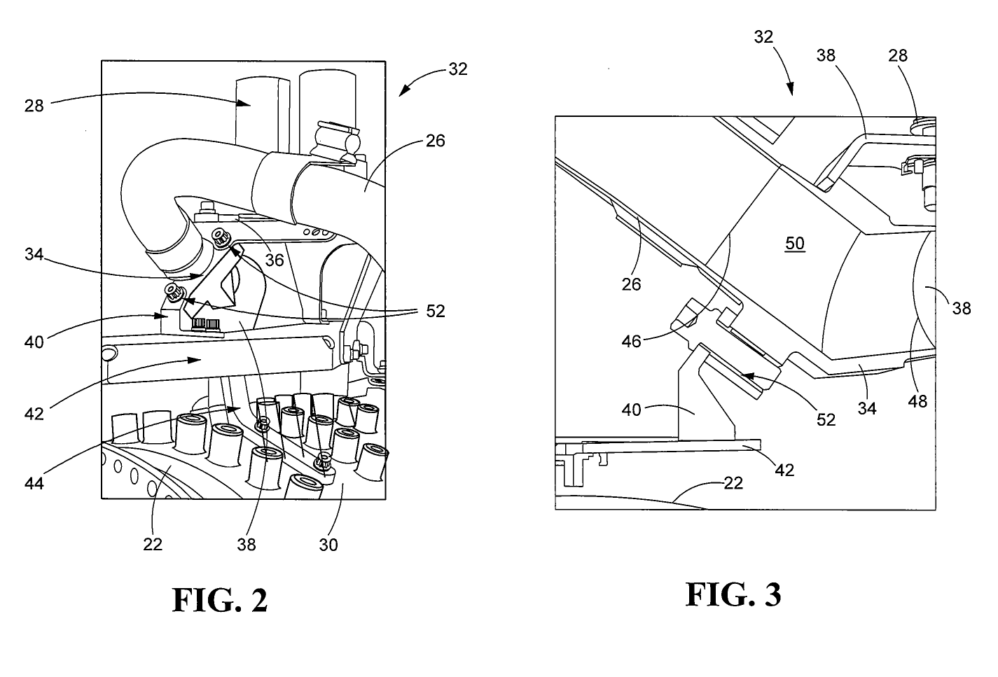

Referring now to FIG. 2, the mounting system 32 includes the tube fitting 34 which enables a first tube 26 to be connected to a second tube 38. In addition, it will be noted that the tube fitting 34 is connected to the engine case 22 by a bracket 40. While the system 32 is depicted in FIG. 2 as having multiple brackets 40, 42 and 44 to connect to the tube fitting 34 to the engine case 22, it is to be understood that a greater or lesser number of brackets can of course be employed.

Also shown in FIG. 2 is the mounting surface 36 extending from the tube fitting 34. The mounting surface 36 can be provided in any number of shapes and sizes depending on the shape, size and mounting requirements of the line replaceable unit 28. As shown in FIG. 2, the mounting surface 36 is a relatively flat plate to which the line replacement unit(s) 28 is/are removable mounted, but this is only exemplary. However, in compilation, it can be seen that such a mounting system 32 not only provides a mechanism that allows the line replaceable unit 28 to mounted where desired, but does so while not occupying any additional exterior space 30 of the engine 22, and at the same time providing a structurally sound load path for the line replaceable unit 28 to the mounting surface 36, to the tube fitting 34, to the brackets 40, 42 and 44, and all the way down to the engine case 22.

In the cross-sectional view of FIG. 3, it can be seen that the tube fitting 34 may include a first end 46 and a second end 48 with an internal passageway 50 therebetween. The first tube 26 may connect to the first end 46 in fluid tight fashion, while the second tube 38 may connect to the second end 48 in fluid tight fashion as well. Depending the orientation of the first end 46 and second end 48, the tubes 26 and 38 may be oriented at any desired angle, and at compound angles as well so as to communicate fluid therethrough and to the various components of the engine 20 wherever they may be. In addition, the bracket 40 may be provided with one or more threaded inserts 52 to removably, and securely, connect the bracket 40 to the tube fitting 34.

While the foregoing describes the use of a tube fitting to double as a component mount for a line replaceable unit on a gas turbine engine, it is to be understood that the teachings of the present disclosure encompass many more embodiments as well. For example, any number of other externals, fittings, brackets, and apparatus on the engine case could be configured with mounting apparatus to support a line replaceable unit on a gas turbine engine. In addition, such an approach need not be limited simply to gas turbine engines, but any other type of complex machinery, such as but not limited to, internal combustion engines and machine tools where space is at a premium and yet secure load paths for component mounts is needed.

### INDUSTRIAL APPLICABILITY

From the foregoing, it can be seen that the technology disclosed herein has industrial applicability in a variety of settings such as, but not limited to mounting external components to a gas turbine engine. The teachings of the present disclosure not only enable such externals to be securely mounted with a load path for line replaceable units all the way down to the engine case, but to do so in a manner which occupies very little space on the engine case while at the same time enabling the externals to be mounted in the exact location desired by the engine manufacturer.

What is claimed is:

1. A component mount, comprising:
a tube fitting having a first end and second end;
a bracket extending from the tube fitting; and
a mount extending from tube fitting.

2. The component mount of claim 1, wherein the mount includes a surface to which replaceable parts can be attached.

3. The component mount of claim 1, wherein the tube fitting is fluid tight.

4. The component mount of claim 1, wherein the bracket is adapted to be connected to a case of a gas turbine engine.

5. The component mount of claim 1, further include a first tube connected to the first end of the tube fitting, and a second tube connected to the second end of the tube fitting.

6. A gas turbine engine, comprising:
an engine case;
a tube operatively associated with the engine case;
a tube fitting mounted on the tube;
a bracket connecting the tube fitting to the engine case; and
a mount extending from the tube fitting.

7. The gas turbine engine of claim 6, further including a line replaceable unit mounted to the mount.

8. The gas turbine engine of claim 7, wherein the line replaceable unit is a filter.

9. The gas turbine engine of claim 6, wherein the tube fitting includes first and second ends, the tube being connected to the tube fitting first end, and a second tube connected to the tube fitting second end.

10. The gas turbine engine of claim 6, further including a second bracket connecting the tube fitting to the engine case.
